(19) United States
(12) Patent Application Publication
(10) Pub. No.: US 2006/0149575 A1
(43) Pub. Date: Jul. 6, 2006

(54) Software engineering process monitoring

(76) Inventors: Srinivas Varadarajan, Bangalore (IN); Sanjaya Ganesh Hariharan, Bangalore (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/029,844

(22) Filed: Jan. 4, 2005

(51) Int. Cl. G06Q 99/00; G06F 15/02; H04M 3/51; G06F 9/46; G06F 11/34

(52) U.S. Cl. 705/1; 705/9; 705/11

(57) ABSTRACT

A computer software engineering process monitoring application for monitoring a project including a software engineering process is disclosed. The computer software engineering process monitoring application comprising, a plurality of software engineering process monitoring program modules. Each module is configured to monitor at least one attribute of the software engineering process on the basis of one or more software engineering process attribute metrics. The application further comprises an updateable database structure configured to store thereon monitoring data including software engineering process attribute metric data useable by one or more of the program modules and a user interface module for generating a user accessible interface representing an output of at least one of the monitoring program modules.

### FIELD OF THE INVENTION

The present invention relates to software engineering process monitoring.

### BACKGROUND OF THE INVENTION

Software is increasingly becoming mission critical to businesses. Thus, it is important to ensure reliability and quality of software used by such businesses.

The reliability and quality of software or software components is largely dependent on the software engineering processes used to develop and/or maintain the software. A software engineering process is defined as a process, practice or activity that is used by an organization or individual to develop and/or maintain software and/or its associated products. Associated products can include but are not limited to software design project plans and specifications, computer code and user manuals.

Many organizations have recognized that improved software quality can be obtained by implementing processes and/or systems for monitoring their software engineering processes. Formalized processes like the Software Engineering Institute (Capability Maturity Model) (SEICMM) developed at Carnegie Mellon University exist, but widespread and rapid adoption of such formalized monitoring systems or processes has not-occurred.

Some organizations consider that implementing this type of formal monitoring system for software engineering processes is prohibitively expensive, time consuming and complex. Factors contributing to this perception can include:
Measurement and collection of process data from various software engineering processes in the organization is often difficult. Automation is therefore advantageous.
Process data would ideally be measured and tracked continuously at various levels in an organization.
Software engineering processes are subject to improvement over time. Hence, it becomes expensive to enhance the monitoring process to keep up with the improvements in the software engineering process.
Organizational factors can influence the effectiveness of the processes once implemented, e.g. organizations undergo structural changes like mergers, acquisitions or due to staff/management re-organization.

### SUMMARY OF THE INVENTION

In a first aspect the present invention provides a software engineering process monitoring application for monitoring a project which includes a software engineering process. The computer software engineering process monitoring application includes, a plurality of software engineering process monitoring program modules configured to monitor at least one attribute of the software engineering process on the basis of one or more software engineering process attribute metrics, an updateable database structure configured to store thereon monitoring data including software engineering process attribute metric data useable by one or more of the program modules, and a user interface module for generating a user accessible interface representing an output of at least one of the monitoring program modules.

### BRIEF DESCRIPTION OF THE DRAWINGS

Exemplary embodiments of the present invention is now described by way of non limiting example only, with reference to the accompanying drawings in which:

FIG. 1 shows a schematic view of the architecture of a computer software engineering process monitoring application in accordance with an embodiment of the present invention;

FIG. 2 shows an exemplary interface of an effort management program module of an embodiment of the present invention.

FIG. 3 shows a flowchart depicting a peer review process implemented by a peer review program module of an embodiment of the present invention;

FIG. 4 shows a flowchart depicting the dataflow in the peer review process depicted in FIG. 3 in accordance with an embodiment of the present invention; and

FIG. 5 depicts a user interface enabling creation of derived metrics for use in an embodiment of the present invention.

### DETAILED DESCRIPTION OF THE EMBODIMENTS

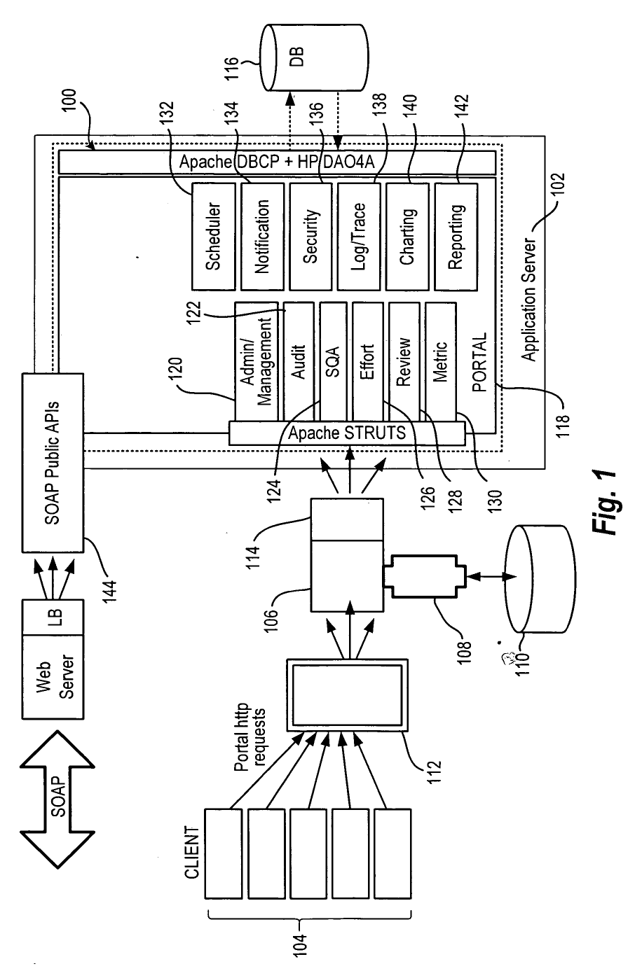

An embodiment of an application for monitoring a software engineering process is now described in connection with FIGS. 1 to 4 of the accompanying drawings. The application can be accessed as a web service by a thick client or through browser software. The disclosed embodiment of the application is implemented as a web portal which is accessible by a plurality of clients via a computer network.

The illustrative embodiment is described in the context of a project including a software engineering process, that is being undertaken by an organization. Such a project has a plurality of members of the organization contributing to it in a range of capacities, including staff members and managers. The project may include a plurality of sub projects, being discrete tasks that one or more members of the organization is responsible for completing.

FIG. 1 shows a schematic view of the architecture of a computer software engineering process monitoring application in accordance with a first embodiment. The software engineering process monitoring application 100 is implemented as software running on an application server 102. The application server 102 is connected to a plurality of client terminals 104 via a web server 106. The web server 106 is configured to restrict access to the software engineering process monitoring application to authorised users using a user authentication utility 108. The user authentication utility 108 is in communication with an LDAP/enterprise directory 110. The web server can be connected to any number of client terminals 104 via one or more intermediate network elements such as router 112. The web server 106 is also associated with a load balancing proxy 114 which manages connections between the application server 102 and the web server 106.

The server 102 provides a web connection to client terminals via web server 112 which enables users of client terminals (e.g. terminal 104) to access the system 100 via a web-based graphical user interface. A SOAP interface 144 is also provided to enable other applications to interact with the system 100. Alternatively another type of interface such as Open Database Connectivity (ODBC) or Java Database connectivity (JDBC) interface (not shown) could be provided As will be appreciated this type of connection enables users to build their own custom user interface to the system.

In an embodiment, the application server 102 is in data communication with a database 116 that is configured to store thereon one or more database structures which are accessible by the software engineering process monitoring application 100.

The application server 102 runs a plurality software modules which together provide functionality of the software engineering process monitoring application. Each of the program modules is responsible for monitoring a different aspect of the software engineering process. Each of the software modules is implemented as an independent J2EE (Java 2 Platform Enterprise Edition) web application. The application 100 uses object relational mapping tool (HP DAO4A, Castor) and Apache's DBCP to manage the persistence and connection pooling. Each of the software modules is pluggable into the application portal architecture. The metric management module 130 is presented below as an example of this pluggable model.

The software engineering process monitoring program modules 118 used in the exemplary embodiment include the following modules.

Software Engineering Process Administration and Management Module (120)

The management module 120 provides an interface which allows certain designated users of the portal to manage the software engineering process monitoring operation. This software module 120 provides a central point for controlling access and management of the portal.

Audit Program Module (122)

The audit program module 122 is configured to facilitate the implementation of quality audits and tracking of audit action and results. The audit program module 122 is set up to track whether the software engineering process being implemented by members of the organization is being implemented according to the software engineering process guidelines set down by the organization. Typically the audit process is performed in audit cycles in a manner which is known to those skilled in the art. The audit program module 122 facilitates the management of audit cycles and audit schedules for members of the organization.

Typically the audit software module 122 is configured to generate various reports showing the status of selected aspects of project. The reports are generated on the basis of metric data sourced via the metric program module 130.

Suitable metrics for use by the audit program module 122 include measures of the time taken to rectify audit items found to be in non-compliance with the organizations designated software engineering process, such as, a metric measuring the audit non-compliance close delay and the audit non-compliance average close duration.

Software Quality Assurance Program Module (124)

The software quality assurance program module 124 is a tool used by members of the organization to monitor software quality assurance of the project being monitored.

The software quality assurance program module 124 aids the project manager and the team members to track the various software quality assurance metrics defined for the project or software engineering process on a periodic basis. This module also provides various reports for tracking the metrics relevant to the project or process.

Effort Program Module (126)

The effort program module 126 is a software engineering process monitoring tool which enables project planning and staff effort tracking, such as timesheet entry, to be performed.

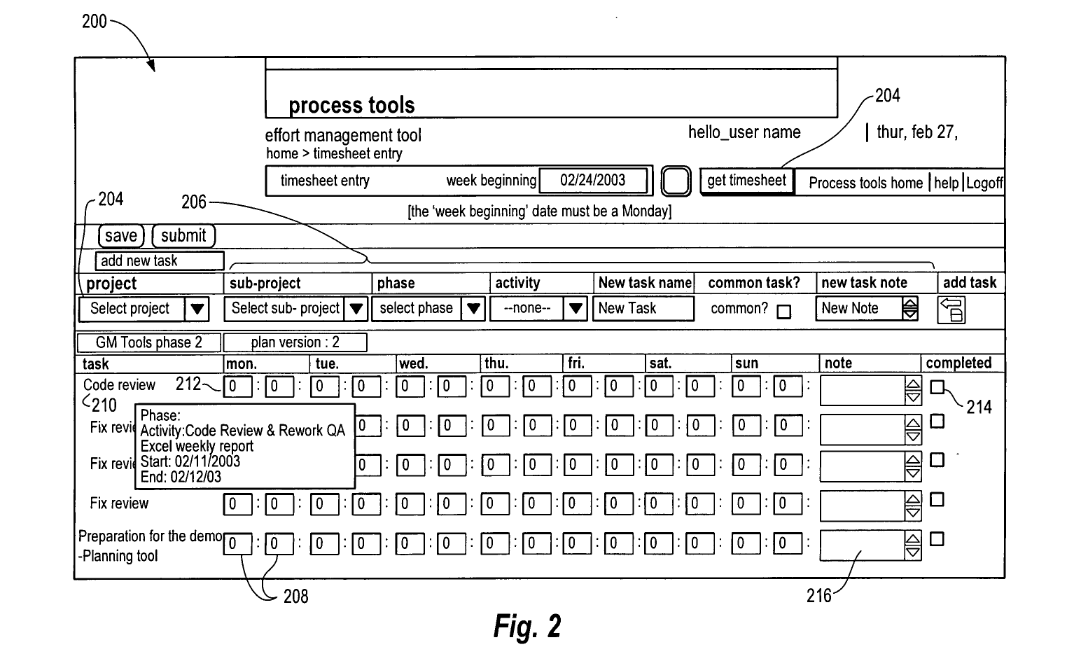

The effort program module 126 is configured to be integrated with, or receive data from, other applications such as Microsoft Project or other similar application. For example a member of the organization, typically the project manager uploads the Microsoft Project plan into the software engineering process monitoring system. Tasks are identified within the Microsoft Project plan for the project and one associated with deliverables tracked by the effort program module 126. Timesheet entry and timesheet workflow, is monitored using the effort program module 126. FIG. 2 shows an exemplary interface in the form of a webpage that is used for timesheet entry in an embodiment of the effort program module 126.

In FIG. 2, the interface 200 takes the form of a grid into which a member of the organization can enter his or her time spent on particular tasks associated with the project. The data corresponding to the time entry is displayed in the interface 200 in textbox 202. The organization member can select the name of the project using drop-down menu 204 and select the appropriate project, day and activity for which time is being entered. Alternatively, he or she can set up a new task using the appropriate drop-down menu of the textbox illustrated at 206.

The time entry grid has a plurality of columns each corresponding to a day of the week into which time is entered in an hours and minutes format into the appropriate textbox e.g. 208. The rows of the time entry grid correspond to tasks which must be completed in order to complete an activity or sub-project within the user's selected project. In the present example, one of the tasks to be performed by the user is a code review. As indicated at 210 the time spent on code review for each day of the week can be entered by the user, by entering time data in the time entry field corresponding to the days on which code review activity was performed. When a task is completed the user ticks the checkbox corresponding to the task, as indicated at 214. The user is also able to make notes regarding particular tasks by entering text into the note field 216.

As described in more detail below, the metric management program module 130 is configured to store metric information for analysing time and other effort related data entered into the software engineering process monitoring application. Exemplary effort metrics include:

| Process metric | Definition |
|---|---|
| Effort variance | (Actual effort − estimated |
| | effort)*100/actual effort |
| Schedule variance | (Actual end date − planned |
| | end date)/planned end date − |
| | planned start date) |
| Cost variance | (Actual supply deliverable |
| | costs/planned (committed) |
| | supplier deliverable costs) |

Peer Review Program Module (128)

The peer review program module 128 is configured to enable deliverables associated with the project, such as code segments written by particular members of the organization to be reviewed and commented upon by another member of the organization. As will be described below the peer review program module 128 is configured to be inter-operable with both the effort tool 126 and the metric management tool 130.

In an embodiment the participants in the peer review process are the “review owner” who is the person who is the primary author of the deliverable being reviewed, a “review moderator” who moderate and tracks the review process through to closure, and a “review inspector” who performs a review of the deliverable.

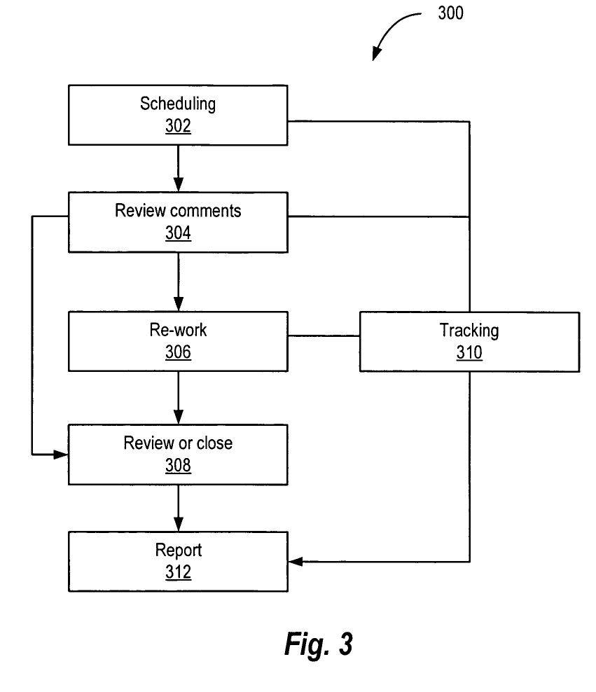

The exemplary reviewing process includes the steps as depicted in the flowchart of FIG. 3.

The review process 300 begins by scheduling of a peer review process at step 302. The scheduling step is initiated by the review owner by uploading the deliverable to be reviewed. The review owner also selects participants and assigns roles to the participants. The peer review program module 128 interacts with the effort capture tool 126 to schedule the peer review process.

In step 304 the review inspector logs into the peer review program module 128 to enter his or her review comments in respect of the deliverable under review. Next at 306 once all of the reviewers have entered their comments the review process 300 moves either for a “rework” state in which the review owner responds to all of the reviews comments, or to the next step 308. The comments entered by the review inspectors may require the review owner to perform additional work on (re-work) the deliverable to bring up to the standard expected by the review inspectors.

In step 308 the review moderator views all of the comments made by the review inspectors and the review owner and may choose to close the review or initiate a re-review of the deliverable.

At any point throughout the process any of the review participants can log into the peer review program module 128 and inspect the status of the peer review process as indicated at step 310.

At the end of the review, process reports are generated which show the item of the review process in terms of a chosen or predetermined set of review metrics.

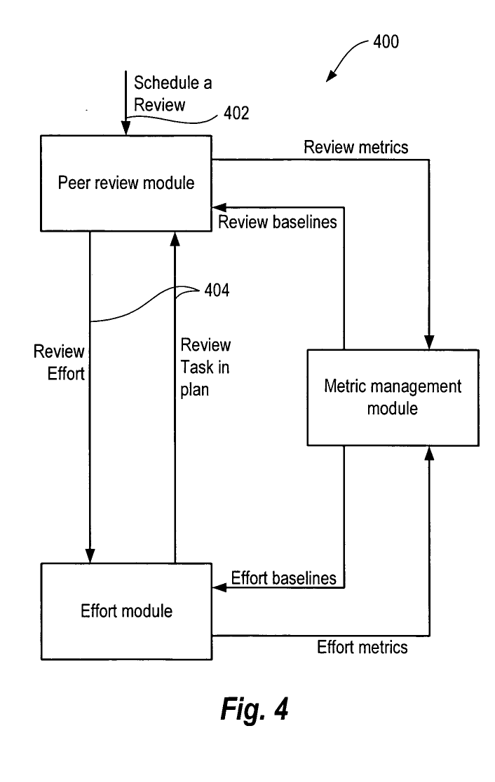

FIG. 4 shows the data flows in the peer review process. The data flow diagram 400 depicts the interaction between the review program module 128, the metric management module 130 and the effort management module 126 of the software engineering process monitoring application 100.

As described above in connection with FIG. 3 the peer review process is begun by the review owner by scheduling the review as indicated at 126. Scheduling the review causes the Peer review program module 128 to interact with the effort program module 404 to perform such tasks as, booking time in the review participants' respective diaries in which to conduct the review, retrieve effort data for the task under review and to record the time taken by each participant in the review.

The effort management module 126 interacts with the metric management module 130 to send effort baselines to the effort management module 126 and to obtain data for setting effort baselines. The effort baseline data is used to schedule peer reviews. Similarly, review baselines are pushed to the review module 128 by the metric management module 130 for use in the peer review process. Upon completion the peer review, the results of the review are pushed to the metric management module 130 for future use.

Metric Management Module (130)

The metric management module 130 is the central repository of metric data for the entire software management monitoring application 100. The metric management module 130 facilitates the definition, amendment, capture and retrieval of the organization's software engineering process metrics. The metric data includes global metric data used across the whole organization and hierarchy specific metrics that are only used at certain management levels within the organization. Certain users of the application or groups within the organization will also define their own specific metrics to monitor performance in an area of performance relevant to the group.

The metric management module 130 has a flexible metadata model, be described below and provides an interactive graphical user interface for organization members to define, track and modify process metrics. In use, each process monitoring module pushes corresponding process metric data to the metric management module 130 and the effort data to the effort program module 126.

In the metric management module 130 a set of schemas defines the metadata model for the metrics. An external data source is able to push base process metrics (raw process metrics) to the metric tool by following a pre-defined schema.

The metric management module 130 is configured to enable external software modules and data sources to feed raw process metric data to it, for example, upon the occurrence of a predetermined trigger event.

To enable this the raw metric data pushed to the metric tool follow:
A predetermined schema for the actual data exchange
A predetermined schema for defining attributes for the raw process metrics

The metric management module 130 considers any new process metric as a ‘black box’ defined by a standard metadata. Raw process metrics from various tools and external data sources can be aggregated and evaluated using the metric management module 130 expression builder capabilities to obtain ‘derived process metrics’ that convey information in a form desired by particular members of the organization.

When data relating to the raw metrics is captured from projects, analysis can be done at any derived metric level. As shown, the derived metrics are definable at any hierarchy within an organization and use of certain metrics could be mandated for all subordinate levels of the organization or it could be defined optional at a particular level.

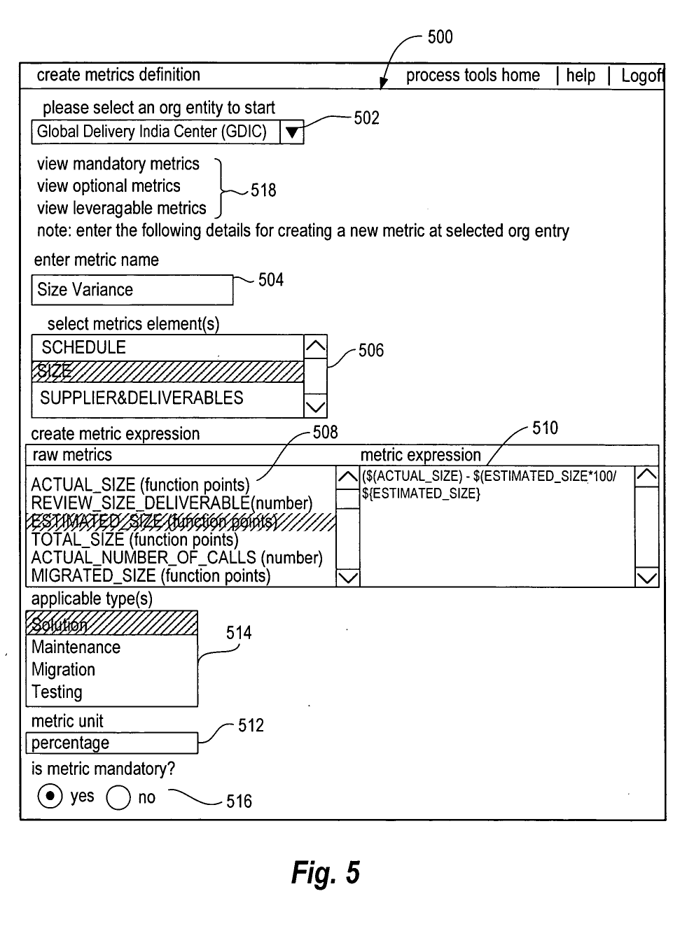

Derived metrics are obtained by applying statistical and/or mathematical formulae to the raw metric data. FIG. 5 shows an exemplary user interface that is used to define derived metrics. In this case a “size variance” metric is defined using the raw metrics “actual size” and “estimated size”.

FIG. 5 illustrates an exemplary user interface that allows the creation of derived metrics for use by one or more entities within the organization. In the user interface 500, the entity within the organization that is establishing the new metric to be created is selected from the dropdown menu 502. Then user then names the new metric using the “enter metric name” using text box 504. Each metric created is defined as belonging to a class of metrics depending on what area of process performance it relates to, for example metrics related to effort will belong to an “effort” class, whereas metrics related to scheduling of tasks will belong to a class named “schedule”. The metric classes typically correspond to the particular program modules that uses the metric. In the present example the metric being defined is a “size” metric, as indicated at 506.

Creation of the mathematical expression is performed using the raw metric list 508 and the “metric expression” text box 510. The user selects the metrics that they wish to use from the raw metrics listed in list 508 and enters a mathematical expression defining how the raw metrics chosen are combined to generate the derived metric in the metric expression box 510. As will be appreciated from the metric expression, the exemplary derived metric “size variance” is the difference between the actual size and estimated size represented as a percentage of the estimated size. This is confirmed by the “metric unit” text field 514 which is set as a “percentage”. The metric unit field tells the user in what units the metric output are provided, e.g. dollars, percentage, hours etc.

The applicable types menu 514 allows the user defining the metric to specify the type of process for which the metric applies.

The user also sets whether the metric is mandatory for this type of process by selecting the appropriate button at 516.The interface 500 also enables a user to view and possibly edit (depending on permissions/authority of the user) the metrics applicable to his or her entity, by selecting the appropriate link at 518.

The metric tool also facilitates the use of ‘leverageable process metrics’ that are derived from external or supplementary metric data sources. In this regard, the organization undertaking the software engineering process can use the process metrics already defined by other entities, such as its customers or suppliers. In order to facilitate the interface between the supplementary metric data sources and the metric tool, the metric tool can be provided with plug-in modules.

Entities within the organization are able to enforce data collection for specific process metrics by defining mandatory process metrics at (typically subordinate) levels within the organization hierarchy The metric management program module is also configured to enable a user of the application to amend previously defined metrics. A user's ability to amend a given metric is controlled by permissions assigned to the user. For example most users are only be allowed to amend derived metrics that he/she has created, whereas administrators are allowed to change metrics globally.

Scheduler Program Module 132

Scheduler program module 132 is used for scheduling various events and operations that need to occur periodically in the portal to support the processes. Scheduler program module 132 allows the system 100 to drive the monitoring processes proactively, by using alerts and notifications at periodic intervals, sending periodic scheduled reports to concerned parties etc. It also executes periodic jobs in the portal including summarizing metrics, archiving and purging data, and generating periodic scheduled reports at pre-defined intervals.

Notification Program Module 134

Notification program module 134 sends proactive or reactive notifications to users via SMTP if certain events take place. For example an email alert is sent to a user when an event of interest occurs such as “a timesheet is submitted for your approval”, “a review has been initiated with you as inspector” etc. Notification module 134 also responds to specific user requests to send bulk notifications, for example when a review owner requests the system to send an invitation to all participants of the review, or similar. The notification program module 134 is also configured to issue reminders of deadlines or actions that need to be performed by a user/member of the organization. The notification program module 134 is configured to allow a user to determine how and when reminders or alerts are issued. For example a user is allowed to set the frequency of reminders and the form of delivery of reminders.

Security Program Module 136

Security program module 136 handles pluggable and configurable access control features. Depending on the security system being used (LDAP Authentication, Third Party Products for SSO etc), this module extracts the required information in the available format. This module can help derive the security credentials required for the operation of the portal irrespective of the corporate security infra-structure.

The system 100 also includes other program modules, the functions of which are readily ascertainable by those skilled in the art. The Logging and Tracing module 138 allows logging of important system activities to a target file system or console.

The Charting program module 140 allows the building of custom charts and the Reporting program module 142 allows customized reports, using Microsoft Excel or the like, to be supplied on demand to end users.

Advantageously, certain embodiments of the present invention provide an integrated and flexible tool to enable an organization to monitor the software engineering activities of its members, and in particular to track the progress of projects with a software engineering component. Advantageously, by using a modular approach and flexible metric definitions the software engineering process monitoring application is reconfigurable to meet changes in the project or the organization.

It will be understood that the invention disclosed and defined herein extends to all alternative combinations of two or more of the individual features mentioned or evident from the text or drawings. All of these different combinations constitute various alternative aspects of the invention.

The foregoing describes embodiments of the present invention and modifications, obvious to those skilled in the art can be made thereto, without departing from the scope of the present invention.

1. A computer software engineering process monitoring application for monitoring a project including a software engineering process, the computer software engineering process monitoring application comprising,
a plurality of software engineering process monitoring program modules, each module being configured to monitor at least one attribute of the software engineering process on the basis of one or more software engineering process attribute metrics,
an updateable database structure configured to store thereon monitoring data including software engineering process attribute metric data useable by one or more of the program modules and
a user interface module for generating a user accessible interface representing an output of at least one of the monitoring program modules.

2. The computer software engineering process monitoring application of claim 1 wherein the plurality of software engineering process monitoring program modules includes a metric module to enable management of software engineering process attribute metric data stored in the database structure.

3. The computer software engineering process monitoring application of claim 2 wherein the metric management module retrieves software engineering process attribute baseline data stored in the database structure for use by other software engineering process monitoring program modules.

4. The computer software engineering process monitoring application of claim 2 wherein the metric management module is configured to capture software engineering process attribute metric data from other software engineering process monitoring program modules for storage in the database structure.

5. The computer software engineering process monitoring application of claim 2 wherein the metric management module is configured to enable attribute metrics to be defined.

6. The computer software engineering process monitoring application of claim 1 wherein the database structure is further configured to store therein organizational data relating to the project being undertaken.

7. The computer software engineering process monitoring application of claim 6 wherein the plurality of software engineering process monitoring program modules includes a project data module to enable management of organizational data defining the project being undertaken that is stored in the database structure.

8. The computer software engineering process monitoring application of claim 1 wherein the plurality of software engineering process monitoring program modules includes a module for monitoring work activity of members of the organization related to the project.

9. The computer software engineering process monitoring application of claim 8 wherein the module for monitoring work activity of members of the organization related to the project is configured to allow monitoring of time-related aspects of the work activity of members of the organization.

10. The computer software engineering process monitoring application of claim 1 wherein the plurality of software engineering process monitoring program modules includes a module for auditing the software engineering process.

11. The computer software engineering process monitoring application of claim 1 wherein the plurality of software engineering process monitoring program modules includes a quality assurance module.

12. The computer software engineering process monitoring application of claim 1 wherein the plurality of software engineering process monitoring program modules includes a module to implement a peer review process.

13. The computer software engineering process monitoring application of claim 5 wherein the metric management module is configured to receive metric data to define a new software engineering process attribute metric to be used by one or more of the software engineering process monitoring program modules.

14. The computer software engineering process monitoring application of claim 2 wherein the metric management module is further configured to enable previously defined software engineering process attribute metrics to be modified.

15. The computer software engineering process monitoring application of claim 14 which is further configured enable data stored in the database structure to be retrieved from the database in the event that a metric used to generate said data has been modified.

16. The computer software engineering process monitoring application of claim 1 adapted for use a plurality of users arranged in an organizational hierarchy, wherein the metric data made available for use by the application is dependent upon a hierarchical level of the user of the application.

17. The computer software engineering process monitoring application of claim 16 wherein the metric management module is configured to enable attribute metrics to be defined by a user at any level within the organizational hierarchy.

18. The computer software engineering process monitoring application of claim 17 wherein the metric management module is configured to enable a user to define a metric useable by members of the organization at level of the organizational hierarchy subordinate to said user.

19. The computer software engineering process monitoring application of claim 18 wherein the metric management module is configured to enable a user, when defining a metric useable by members of the organization at level of the organizational hierarchy subordinate to said user to indicate whether the use of a defined attribute metric is mandatory or optional.

20. The computer software engineering process monitoring application of claim 1 wherein the plurality of software engineering process monitoring program modules includes a notification module configured to issue at least one of the following:
a notification in the event that a predefined alert condition occurs;
a reminder of an upcoming event based on one or more of said attribute metrics.

21. The computer software engineering process monitoring application of claim 20 wherein the notification module is configured to enable a user to define at least one of the following notification parameters:
an alert condition;
a form of a notification;
a form of a reminder;
a number of reminders to be issued; and
a frequency of issuance of reminders.

22. The computer software engineering process monitoring application of claim 7 wherein the project data module is further configure to enable updating of organizational data defining the project being undertaken stored in the database structure

23. The computer software engineering process monitoring application of claim 2 wherein the metric management module is further configured to include one or more metric capture plug-ins to enable the capture of software engineering process attribute metric data from one or more supplementary metric data sources, for storage in the database structure.

24. The computer software engineering process monitoring application of claim 2 which includes a data importation portion configured to enable uploading of previously captured metric data into the database structure.

25. The computer software engineering process monitoring application of claim 2 including a data exchange interface configured to receive data from another application according to a predetermined metadata format.

26. The computer software engineering process monitoring application of claim 11 wherein the quality assurance program module is configured to maintain one or more checklists usable to monitor compliance with a software engineering model.

27. A computing device configured to monitor a computer software engineering process, comprising:
a processor operating under control of an application program comprising a plurality of software engineering process monitoring program modules, each module being configured to cause the system to monitor at least one attribute of the software engineering process on the basis of one or more software engineering process attribute metrics, and a user interface module for generating a user accessible interface representing an output of at least one of the monitoring program modules;
a data storage including an updateable database structure configured to store thereon monitoring data including software engineering process attribute metric data useable by one or more of the program modules.

28. The computing device of claim 27 wherein the plurality of software engineering process monitoring program modules includes a metric module to enable management of software engineering process attribute metric data stored in the database structure.

29. The computing device of claim 28 wherein the wherein the metric management module is configured to cause the processor to retrieve software engineering process attribute baseline data stored in the database structure for use by other software engineering process monitoring program modules.

30. The computing device of claim 28 wherein the metric management module is configured to cause the processor to capture software engineering process attribute metric data from other software engineering process monitoring program modules for storage in the database structure.

31. The computing device of claim 27 wherein the plurality of software engineering process monitoring program modules includes a project data module to enable management of organizational data defining the project being undertaken that is stored in the database structure.

32. The computing device of claim 27 wherein the plurality of software engineering process monitoring program modules includes a module for monitoring work activity of members of the organization related to the project.

33. The computing device of claim 27 wherein the plurality of software engineering process monitoring program modules includes a module for auditing the software engineering process.

34. The computing device of claim 27 wherein the plurality of software engineering process monitoring program modules includes a quality assurance module.

35. The computing device of claim 27 wherein the plurality of software engineering process monitoring program modules includes a module to implement a peer review process.

36. The computing device of claim 28 wherein the metric module is configured to allow an attribute metric to be defined or edited.

37. The computing device of claim 27 wherein the plurality of software engineering process monitoring program modules includes a notification module configured to issue at least one of the following:
a notification in the event that a predefined alert condition occurs;
a reminder of an upcoming event based on one or more of said attribute metrics.

38. The computing device of claim 31 wherein the project data module is further configure to enable updating of organizational data defining the project being undertaken stored in the database structure.

39. The computing device of claim 28 wherein the processor is configured to upload metric data into the database structure of the data storage.

40. The computing device of claim 27 including a data exchange interface configured to enable metric data to be exchanged with another computing device according to a predetermined metadata format.

41. The computing device of claim 27 which further includes at least one interface portion configured to generate user interface data for provision to a user's computing device.
